(19) United States
(12) Patent Application Publication
(10) Pub. No.: US 2006/0236273 A1
(43) Pub. Date: Oct. 19, 2006

(54) System, method and program for designing a semiconductor integrated circuit using standard cells

(75) Inventor: Takeshi Ishigaki, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/392,563

(22) Filed: Mar. 30, 2006

(30) Foreign Application Priority Data
Mar. 31, 2005 (JP) P2005-103689

(51) Int. Cl. G06F 17/50

(52) U.S. Cl. 716/1

(57) ABSTRACT

A computer implemented method for designing a semiconductor integrated circuit includes analyzing information of standard cells to be arranged in a chip area based on circuit behavior information so as to generate standard cell information, generating a mega cell including a group of standard cells, based on the standard cell information, and making a layout in which the same patterns repeat in the chip area by arranging a plurality of the mega cells having the same shape, throughout the chip area based on the circuit behavior information.

### CROSS REFERENCE TO RELATED APPLICATIONS AND INCORPORATION BY REFERENCE

This application is based upon and claims the benefit of priority from prior Japanese Patent Application P2005-103689 filed on Mar. 31, 2005; the entire contents of which are incorporated by reference herein.

### BACKGROUND OF THE INVENTION

1. Field of the Invention

The present invention relates to a system, method and program for designing a semiconductor integrated circuit that uses standard cells.

2. Description of the Related Art

Standard cells are used to reduce a semiconductor integrated circuit design time. In addition, there is a method for improving efficiency in semiconductor integrated circuit mask design by hierarchically arranging standard cells.

However, since there is a large combination of standard cells, use of standard cells for designing a semiconductor integrated circuit increases the number of different layout patterns on a semiconductor integrated circuit. This requires increased time for optical proximity correction (OPC) or the like in layout pattern-dependent mask design. Furthermore, many different layout patterns require a large amount of time for checking whether layout patterns satisfy the design rule.

In addition, design rule errors detected when generating masks may develop a serious problem of time loss due to redesign of a mask. As miniaturization of semiconductor integrated circuits progresses, these problems will become more prominent.

### SUMMARY OF THE INVENTION

An aspect of the present invention inheres in a computer implemented method for designing a semiconductor integrated circuit. The method includes analyzing information of standard cells to be arranged in a chip area based on circuit behavior information so as to generate standard cell information; generating a mega cell including a group of standard cells, based on the standard cell information; and making a layout in which the same patterns repeat in the chip area by arranging a plurality of the mega cells having the same shape, throughout the chip area based on the circuit behavior information.

Another aspect of the present invention inheres in a system for designing a semiconductor integrated circuit. The system includes an analyzing module configured to analyze information of standard cells to be arranged in a chip area based on circuit behavior information so as to generate standard cell information; a generating module configured to generate a mega cell including a group of standard cells, based on the standard cell information; and a layout module configured to make a layout in which the same patterns repeat in the chip area by arranging a plurality of the mega cells having the same shape, throughout the chip area based on the circuit behavior information.

Still another aspect of the present invention inheres in a computer program product for operating a design system so as to provide a semiconductor integrated circuit. The computer program product includes instructions configured to analyze information of standard cells to be arranged in a chip area based on circuit behavior information so as to generate standard cell information; instructions configured to generate a mega cell including a group of standard cells, based on the standard cell information; and instructions configured to make a layout in which the same patterns repeat in the chip area by arranging a plurality of the mega cells having the same shape, throughout the chip area based on the circuit behavior information.

### BRIEF DESCRIPTION OF DRAWINGS

FIG. 1 schematically shows a structure of a semiconductor integrated circuit design system according to a first embodiment of the present invention;

FIG. 2 schematically shows an exemplary chip area to which a semiconductor integrated circuit design method is applied according to the first embodiment of the present invention;

FIG. 3 is a flowchart explaining the semiconductor integrated circuit design method according to the first embodiment of the present invention;

FIG. 4 shows information of standard cells, which compose a mega cell, generated using the semiconductor integrated circuit design method according to the first embodiment of the present invention;

FIG. 5 schematically shows an exemplary mega cell generated using the semiconductor integrated circuit design method according to the first embodiment of the present invention;

FIG. 6 schematically shows an exemplary synthesis area generated using the semiconductor integrated circuit design method according to the first embodiment of the present invention;

FIG. 7 schematically shows an example of power supply lines arranged on the synthesis area shown in FIG. 6;

FIG. 8 schematically shows an exemplary arrangement of clock buffers using the semiconductor integrated circuit design method according to the first embodiment of the present invention;

FIG. 9 schematically shows exemplary chip area to which the semiconductor integrated circuit design method is applicable according to the first embodiment of the present invention;

FIG. 10 schematically shows an exemplary mega cell generated based on standard cell information using the semiconductor integrated circuit design method according to the first embodiment of the present invention;

FIG. 11 schematically shows an exemplary mega cell generated using the semiconductor integrated circuit design method according to the first embodiment of the present invention;

FIG. 12 schematically shows an exemplary mega cell including minority standard cells generated using the semiconductor integrated circuit design method according to the first embodiment of the present invention;

FIG. 13 schematically shows an exemplary mega cell including minority standard cells arranged in the synthesis area using the semiconductor integrated circuit design method according to the first embodiment of the present invention;

FIG. 14 schematically shows a structure of a semiconductor integrated circuit design system according to a second embodiment of the present invention;

FIG. 15 is a flowchart explaining a semiconductor integrated circuit design method according to the second embodiment of the present invention;

FIG. 16 schematically shows a structure of a semiconductor integrated circuit design system according to a third embodiment of the present invention;

FIG. 17 is a flowchart explaining a semiconductor integrated circuit design method according to the third embodiment of the present invention;

FIG. 18 schematically shows an exemplary mega cell generated using the semiconductor integrated circuit design method according to the third embodiment of the present invention;

FIG. 19 schematically shows an exemplary mega cell generated using the semiconductor integrated circuit design method according to the third embodiment of the present invention; and

FIG. 20 schematically shows an exemplary mega cell with clock line loads adjusted using the semiconductor integrated circuit design method according to the third embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### First Embodiment

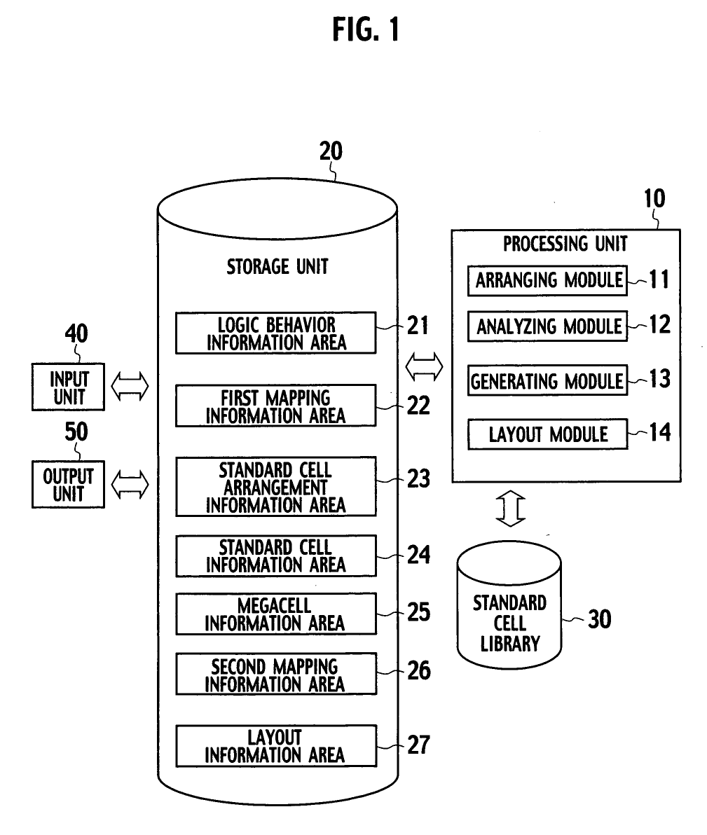

As shown in FIG. 1, a semiconductor integrated circuit design system, according to a first embodiment of the present invention, includes a processing unit 10, a storage unit 20, a standard cell library 30, an input unit 40, and an output unit 50.

The processing unit 10 includes an arranging module 11, an analyzing module 12, a generating module 13, and a layout module 14.

The arranging module 11 arranges a plurality of standard cells on a chip area based on circuit behavior information, and generates standard cell arrangement information. Arrangement of logic gate circuits and interconnects on a chip area is referred to as a ‘layout’. In addition, the arrangement of logic gate circuits and interconnects on a chip area is referred to as ‘to make a layout’. To make a layout, mapping is first carried out based on circuit behavior information. ‘Mapping’ refers to the assigning logic gate circuits to respective logic behaviors so as to exhibit the logic behaviors. A layout is then made based on mapping results (mapping information).

The analyzing module 12 analyzes information of standard cells to be arranged in the chip area based on circuit behavior information so as to generate standard cell information. The information of standard cells to be arranged in the chip area is included in the standard cell arrangement information. ‘Standard cell information’ includes the types, numbers, and on-chip positions of standard cells.

The generating module 13 generates a mega cell that includes a group of standard cells based on the standard cell information. For example, the mega cell includes various types of logic standard cells and memory elements, such as flip-flops and latch circuits.

The layout module 14 makes a layout in which the same patterns are repeated in the chip by arranging a plurality of the mega cells, which are the same shape, throughout the chip area based on the circuit behavior information.

The storage unit 20 includes a logic behavior information area 21, a first mapping information area 22, a standard cell arrangement information area 23, a standard cell information area 24, a mega cell information area 25, a second mapping information area 26, and a layout information area 27. Logic behavior information of circuits is stored in the logic behavior information area 21. First mapping information generated by the arranging module 11 is stored in the first mapping information area 22. The standard cell arrangement information area 23 stores standard cell arrangement information. The standard cell information area 24 stores standard cell information. The mega cell information area 25 stores mega cell information. The second mapping information area 26 stores second mapping information generated by the layout module 14. The layout information area 27 stores layout information.

In addition, information of standard cells available for mapping is stored in the standard cell library 30.

The input unit 40 includes a keyboard, a mouse, and a light pen or a flexible disk unit or other input hardware. A designer may specify input/output data via the input unit 40. It is also possible to specify an output data format, and input an instruction to carry out or abort a design via the input unit 40.

In addition, a display, which displays design results, a printer, or a recording unit having a computer readable recording medium, which stores design results may be used as the output unit 50. Here, ‘computer readable recording medium’ refers to a medium capable of storing electronic data, such as an external memory of a computer, semiconductor memory, a magnetic disk, an optical disk, a magnetic optical disk, and a magnetic tape. More specifically, a ‘computer readable recording medium’ may be a flexible disk, a compact disk read only memory (CD-ROM), or a magneto-optics (MO) disk or any other medium that is readable by a computer.

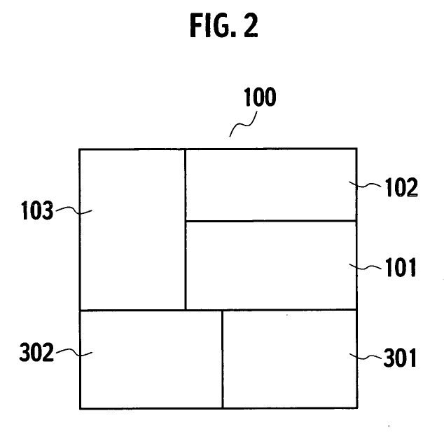

FIG. 2 shows an exemplary layout of a semiconductor integrated circuit. FIG. 2 shows an exemplary arrangement of synthesis areas 101, 102 and 103 and memory macros 301 and 302 on a chip area 100. Circuits generated by logic synthesis based on a circuit behavior description are arranged on the ‘synthesis areas’. Circuits generated by a plurality of logic syntheses are arranged on the synthesis areas 101, 102 and 103 shown in FIG. 2, respectively. Alternatively, a circuit, which is generated by a single logic synthesis, is divided into a plurality of sub-circuits which are then arranged on the respective synthesis areas 101, 102 and 103.

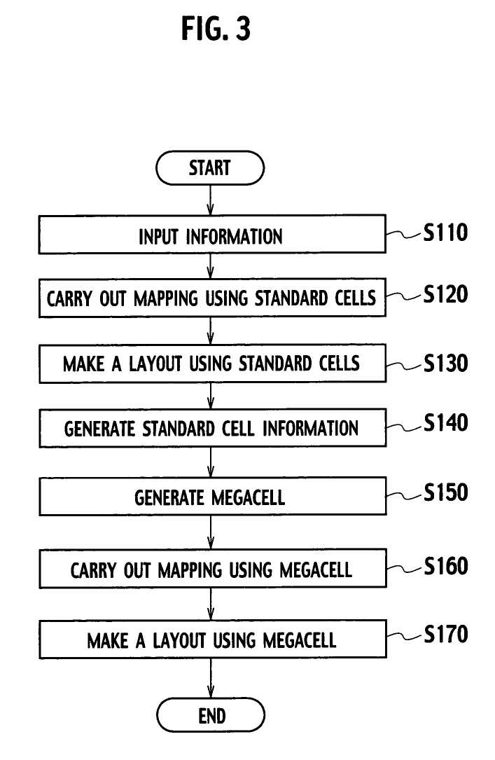

An example of designing a semiconductor integrated circuit by utilizing the design system shown in FIG. 1 is described with the flowchart shown in FIG. 3. An example of making a layout of the synthesis area 101 shown in FIG. 2 is described forthwith.

In step S110, logic behavior information of circuits to be arranged on the synthesis area 101, shown in FIG.2, are stored in the logic behavior information area 21 via the input unit 40 shown in FIG. 1. The logic behavior information is generated by logic synthesis. Alternatively, logic behavior information may be pre-stored in the logic behavior information area 21.

In step S120, the arranging module 11 reads logic behavior information from the logic behavior information area 21. The arranging module 11 carries out mapping based on the logic behavior information. The arranging module 11 accesses the standard cell library 30 for standard cells, carries out mapping using standard cells as logic gate circuits, and then generates first mapping information. The first mapping information is stored in the first mapping information area 22.

In step S130, the arranging module 11 reads the first mapping information from the first mapping information area 22. The arranging module 11 arranges the logic gate circuits on the synthesis area 101 based on the first mapping information, so as to make a layout of the synthesis area 101. Information of arranged standard cells is stored in the standard cell arrangement information area 23 as standard cell arrangement information.

In step S140, the analyzing module 12 reads the standard cell arrangement information from the standard cell arrangement information area 23. The analyzing module 12 generates standard cell information of the standard cells to be arranged in the synthesis area 101 by analyzing the information of standard cells arranged in the chip area, which is included in the standard cell arrangement information. The generated standard cell information is stored in the standard cell information area 24.

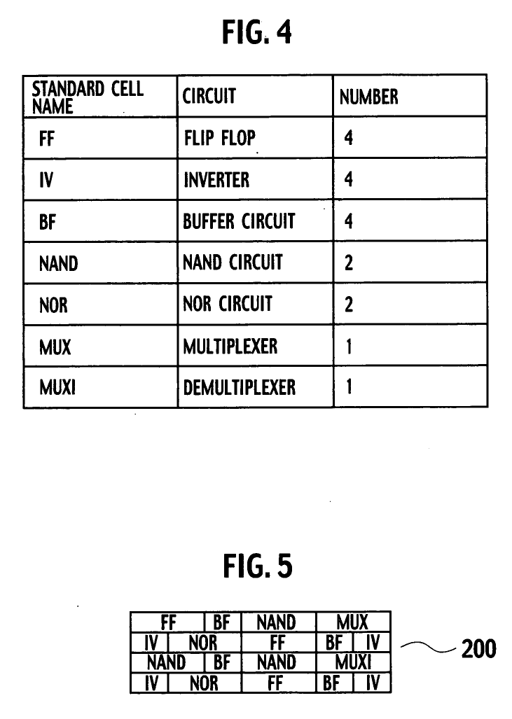

In step S150, the generating module 13 reads the standard cell information from the standard cell information area 24. The generating module 13 generates a mega cell based on the standard cell information. More specifically, the generating module 13 determines the types and number of standard cells, which comprise a group of standard cells included in mega cell, based on the types and the number of standard cells arranged in the synthesis area 101. For example, the types and number of standard cells, which comprise the group of standard cells, are selected based on the types of standard cells to be used and arranged in the synthesis area 101 and the ratio of the numbers of respective types of standard cells. FIG. 4 shows an example of types and number of standard cells selected by the generating module 13. The generating module 13 generates a mega cell based on information shown in FIG. 4, for example. FIG. 5 shows an example of a generated mega cell 200, based on the information of FIG. 4. In addition, when generating the mega cell 200, standard cells are arranged within the mega cell 200 in consideration of the shapes or the like of the respective standard cells. Furthermore, the shape of the mega cell 200 is determined as a specific shape permitting a plurality of mega cells 200 to be arranged throughout the synthesis area 101 in consideration of the shape of the synthesis area 101. For example, the shape of the mega cell 200 is determined to be similar to the shape of the synthesis area 101. In that case, the shape of the mega cell 200 is rectangular when the shape of the synthesis area 101 is rectangular. Mega cell information, such as arrangement of the standard cells within the mega cell 200 and the shape of the mega cell 200, is stored in the mega cell information area 25.

In step S160, the layout module 14 reads the logic behavior information from the logic behavior information area 21 and the mega cell information from the mega cell information area 25. The layout module 14 carries out mapping based on the logic behavior information. The layout module 14 accesses the mega cell information and uses the mega cell 200 as a logic gate circuit. Second mapping information generated by the layout module 14 is stored in the second mapping information area 26.

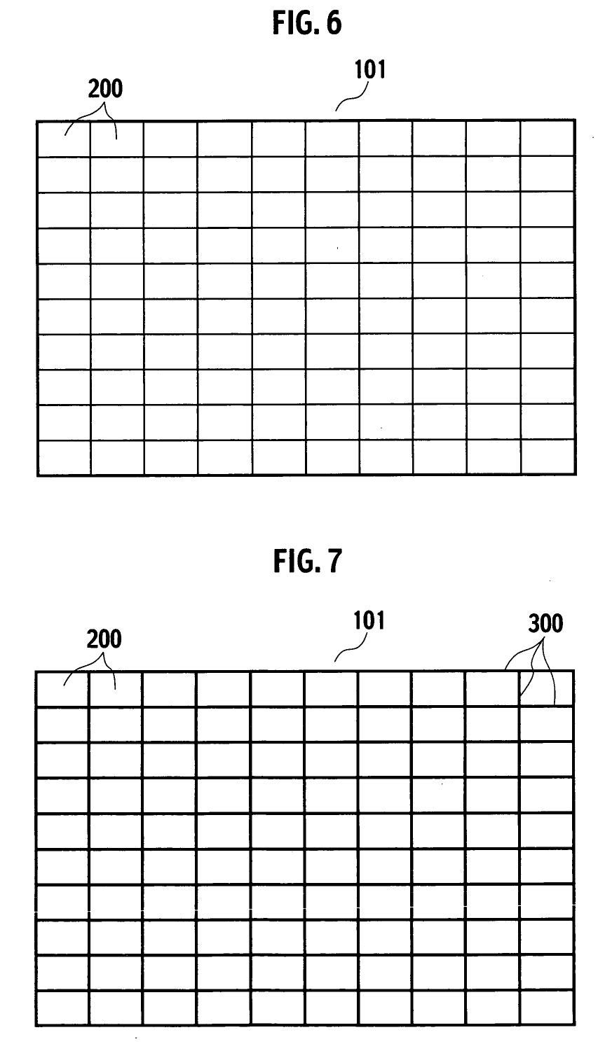

In step S170, the layout module 14 reads the second mapping information from the second mapping information area 26. The layout module 14 arranges and interconnects a plurality of mega cells 200 in the synthesis area 101 based on the second mapping information in order to make a layout of the synthesis area 101. As a result, the mega cells 200 are arranged throughout the synthesis area 101. Layout information, as a result of the arrangement, is stored in the layout information area 27. FIG. 6 is an exemplary structure of the synthesis area 101 including one hundred (10×10) mega cells 200. The layout information can be read from the design system via the output unit 50.

The synthesis areas 102 and 103 shown in FIG. 2 are arranged in the aforementioned manner. Masks are designed based on the layout information of the synthesis areas 101 through 103 and the memory macros 301 and 302.

The synthesis area of a substrate, in which mega cells are arranged, has repetitive layout patterns. In other words, a hierarchical structure of substrate layout data is provided for the synthesis area. For example, the substrate layout pattern in the synthesis area 101 is a repetitive layout pattern of the mega cells 200. Therefore, when the substrate in the synthesis area 101 is subjected to optical proximity correction (OPC), only the mega cells 200 should be subjected to the OPC. In addition, when the substrate in the synthesis area 101 is subjected to design rule checking, only the mega cells 200 need to be subjected to design rule checking. As a result, mask design time is reduced.

In addition, since the mega cells 200 are arranged throughout the synthesis area 101, it is easy to provide a mesh-shaped arrangement of power supply lines and clock lines in the synthesis area 101 is easy. For example, as shown in FIG. 7, the power supply lines 300 can be arranged along the sides of the respective mega cells 200 in the synthesis area 101. The power supply lines 300 can be connected to the mega cells 200 arranged in the synthesis area 101. In other words, because the power supply lines 300 can be easily arranged in the synthesis area 101, the semiconductor integrated circuit design time is reduced.

Furthermore, formation of the mega cells 200 throughout the synthesis area 101 permits uniform distribution of loads, within the synthesis area 101, driven by clock buffers (hereafter, refereed to as ‘clock line loads’), such as input capacitance of the clock input terminal of each memory element. Then, the mega cells are uniformly arranged in the synthesis area 101 to which a clock signal is provided. FIG. 8 shows exemplary positions of mega cells 210 in the synthesis area 101 to which a clock signal is provided. FIG. 8 shows an exemplary arrangement of four mega cells 210 in the synthesis area 101, which includes one hundred (10×10) mega cells. The mega cells 210 shown in FIG. 8 provide a clock signal to the twenty-five (5×5) mega cells 200 arranged to surround the mega cells 210. In addition, since the clock line loads of the respective mega cells 200 are the same, clock skew developed within the synthesis area 101 is decreased. As a result, clock line design time and semiconductor integrated circuit design time is reduced.

Different types of mega cells can be arranged in the synthesis area 101. For example, if there is a non-uniform distribution of the types of standard cells arranged in the synthesis area 101, mega cells including different standard cells can be arranged in the synthesis area 101 according to the distribution of the types of standard cells arranged. Note that the shape of all mega cells is the same so that power supply lines and clock lines can be easily designed in the synthesis area 101. An example of using a plurality of mega cells from which the composition of standard cell differs, respectively, is described forthwith.

The standard cell arrangement information stored in the standard cell arrangement information area 23 includes information of positions of the standard cells arranged by the arranging module 11. Accordingly, it is easy to detect the arranged positions of respective standard cells. Therefore, the analyzing module 12 analyzes the types of standard cells used for each position within the synthesis area 101 based on the standard cell arrangement information. If distribution of the types of arranged standard cells is not uniform, a large amount of pieces of standard cell information is generated.

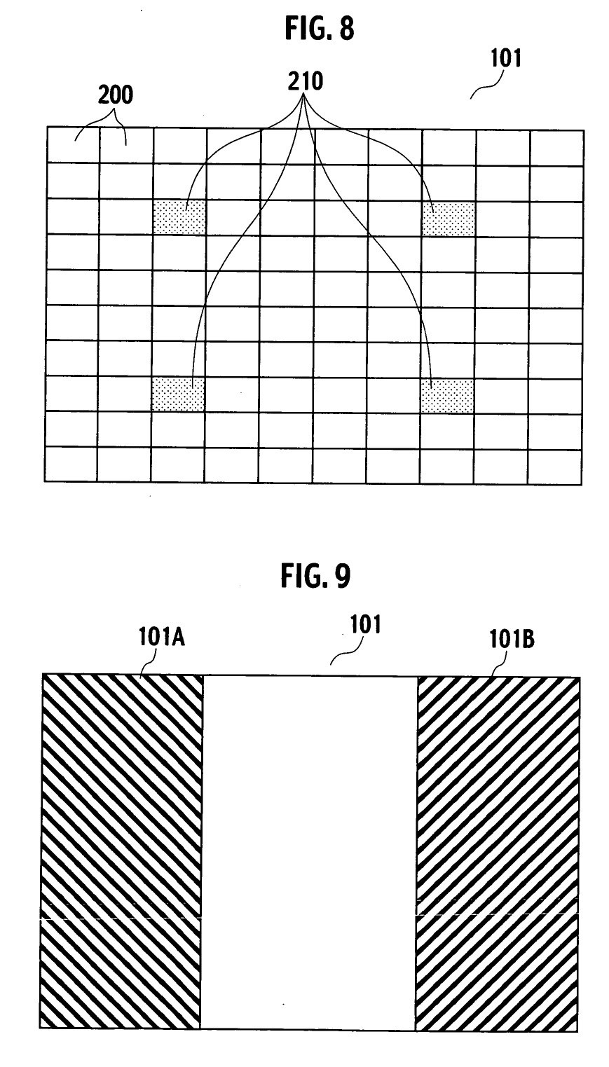

For example, a case where many inverters are arranged in a shaded region 101A of the synthesis area 101 in FIG. 9 and many buffer circuits are arranged in a shaded region 101B is described. Standard cells comprising the mega cell 200 are selected based on the types and number of the standard cells to be used throughout the synthesis area 101. Therefore, if the mega cells 200 are arranged throughout the synthesis area 101, the number of unused buffer circuits BF may increase in the region 101A, and a shortage of the inverters IV may occur. On the other hand, in the region 101B, the number of unused inverters IV may increase, and a shortage of buffer circuits BF may occur.

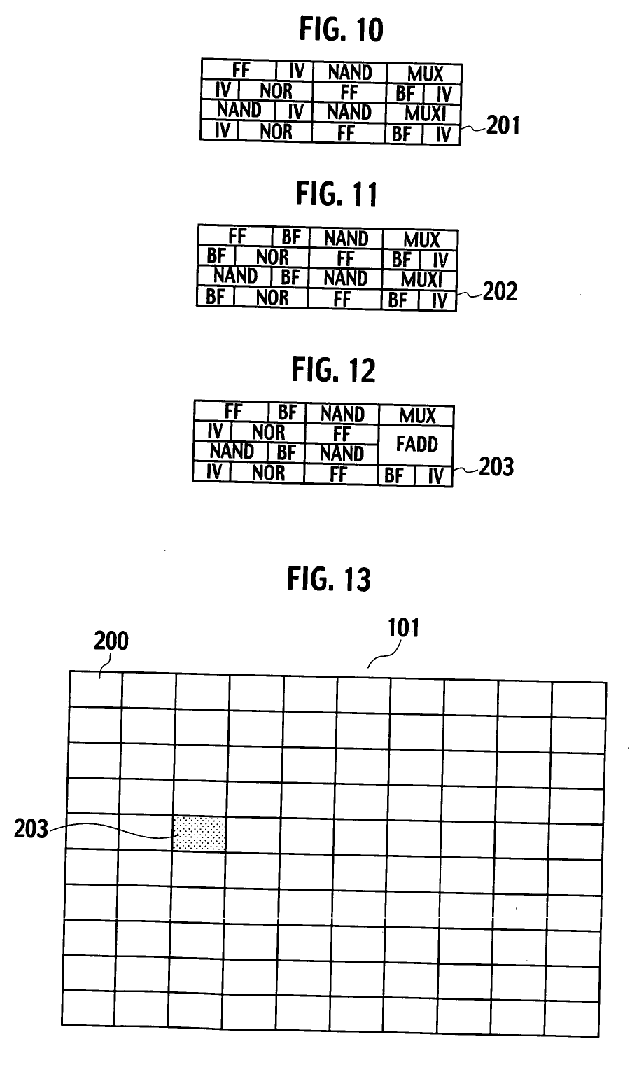

In the embodiment, a plurality of mega cells are generated based on standard cell information of the respective regions 101A and 101B. More specifically, the analyzing module 12 generates standard cell information of the respective regions 101A and 101B. The generating module 13 then generates mega cells based on the standard cell information of the respective regions 101A and 101B. FIG. 10 shows an exemplary structure of a mega cell 201 generated based on the standard cell information of the region 101A. The mega cell 201 includes many inverters IV and few buffer circuits BF compared to the mega cell 200.

On the other hand, FIG. 11 shows an exemplary structure of a mega cell 202 generated based on the standard cell information of the region 101B. The mega cell 202 includes many buffer circuits BF and fewer inverters IV compared to the mega cell 200. The shapes of the mega cells 201 and 202 are the same as the shape of the mega cell 200. Arrangement of mega cells 201 in the region 101A, mega cells 202 in the region 101B, and mega cells 200 in the remaining region in the synthesis area 101, other than the regions 101A and 101B, improves the usage rate of standard cells included in the synthesis area 101. The number of targets to be subjected to OPC is increased in comparison to the case of arranging the same type of mega cells throughout the synthesis area 101. However, the time for mask design may be further reduced in comparison to the case of making a layout of the synthesis area 101 using standard cells.

In addition, when there are standard cell types of which only a small number are used in each synthesis area (hereafter, referred to as ‘minority standard cells’), such as a full adder and a clock buffer, all mega cells need not include such minority standard cells. This is because, when mega cells including the minority standard cells are arranged throughout the synthesis area, the usage rate of standard cells throughout the synthesis area decreases. Therefore, special mega cells including the minority standard cells are generated. The analyzing module 12 can easily determine, from the standard cell arrangement information, whether or not the standard cells are minority standard cells. The analyzing module 12 generates information of mega cells including the minority standard cells. The generating module 13 generates mega cells including the minority standard cells using the information of the mega cells including the minority standard cells. The shape of the mega cells including the minority standard cells is the same as the shape of the other mega cells. FIG. 12 shows an exemplary mega cell 203 including a full adder FADD as a minority standard cell. FIG. 13 shows an exemplary arrangement of the mega cell 203 in the synthesis area 101. The position where the mega cell 203 is arranged is determined based on the standard cell information.

A single type of standard cell may be needed for a plurality of signal paths within a single mega cell. On the other hand, the types and the number of standard cells included in a mega cell are limited. As a result, a signal path that fails to use a standard cell may occur. In such a case, the layout module 14 uses substitute standard cells, which have a functionality equivalent to unavailable standard cells, to form a signal path. ‘Substitute standard cells’ denote standard cells that are generated by combining a plurality of standard cells within a mega cell, or standard cells that have a functionality equivalent to the desired standard cells and a slower operating speed.

In general, the operating speed of the substitute standard cells is slower, compared to the operating speed of the desired standard cell. Therefore, if a single standard cell is needed for a plurality of signal paths, the standard cell is preferentially assigned to a high-speed operating path such as a critical path. On the other hand, the substitute standard cells are assigned to a signal path that does not have severe requirements for operating speed. As a result, a decrease in circuit performance throughout the synthesis area can be controlled.

When standard cells are arranged at arbitrary positions in a chip area without using mega cells, the ratio of the total standard cell area to the chip area is typically approximately 70 to 80%. However, use of the shapes of mega cells in conformity with the shape of the synthesis area can arrange the mega cells throughout the synthesis area. As a result, a design method using mega cells increases the ratio of the total standard cell area to the chip area. In other words, areas on a chip where no standard cells or the like are arranged are decreased, and the chip usage rate improves.

In addition, the arrangement of the standard cells within the mega cells is fixed. Accordingly, layout patterns within the mega cells can be modified across the boundary between standard cells. For example, sharing of a source of a transistor with a plurality of standard cells can reduce the mega cell area. Thus, a layout pattern may be made with an equivalent functionality in a smaller area, compared to a layout pattern generated by a design method without using mega cells.

As described above, according to the semiconductor integrated circuit design method of the first embodiment of the present invention, mapping using mega cells including a plurality of standard cells allows formation of layout data on a synthesis area in a hierarchical structure. In addition, use of mega cells having the same shape facilitates arrangement of power supply lines and/or clock lines. As a result, the mask design time can be reduced. Furthermore, the chip area can be reduced in comparison to the design method without using mega cells.

The semiconductor integrated circuit design method shown in FIG. 3 may be carried out by controlling the design system, shown in FIG. 1, by use of a program having an algorism equivalent to that shown in FIG. 3. This program should be stored in the storage unit 20 of the design system shown in FIG. 1. In addition, the semiconductor integrated circuit design method of the present invention may be carried out by storing such program in a computer-readable recording medium and instructing the storage unit 20 to read the recording medium.

### Second Embodiment

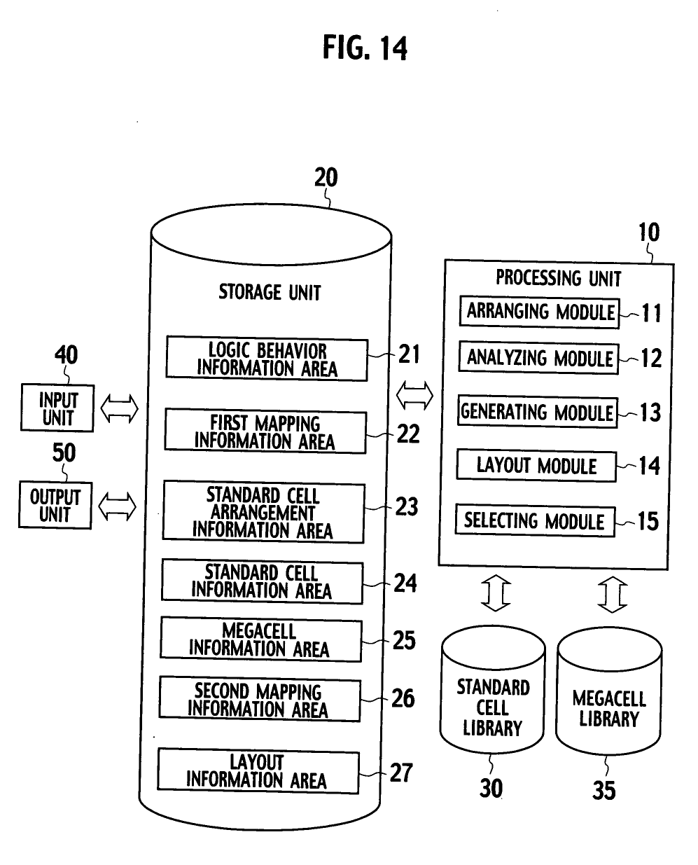

FIG. 14 shows a semiconductor integrated circuit design system, according to a second embodiment of the present invention. The design system shown in FIG. 14 is different from the design system shown in FIG. 1 in that the semiconductor integrated circuit design system further includes a mega cell library 35 and a selecting module 15. A plurality of mega cells are stored in the memory cell library 35. The selecting module 15 selects a mega cell to be used in a synthesis area from the mega cell library 35.

Use of mega cells that have already been generated can reduce the mask design time. For example, the mega cells 200 through 203 generated using the design method shown in FIG. 3 are stored in the mega cell library 35. When designing new masks, if available mega cells are stored in the mega cell library 35, the stored mega cells are used for mask design. If available mega cells are not stored in the mega cell library 35, a new mega cell is generated using the same method described in FIG. 3.

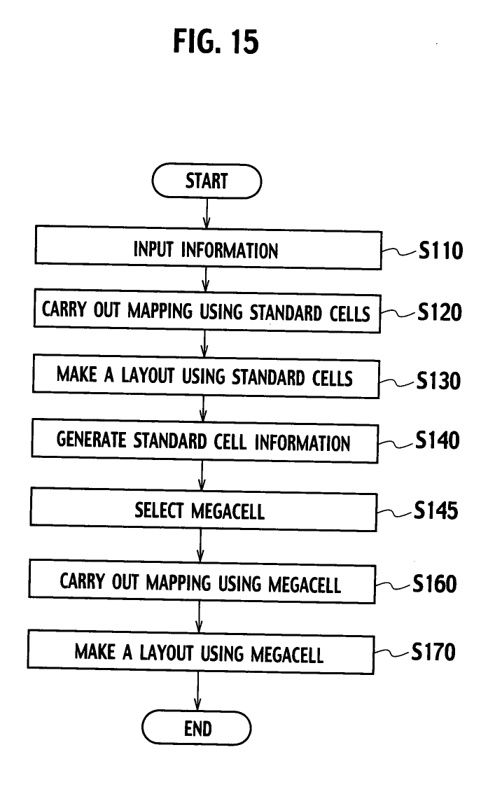

An example of making a semiconductor integrated circuit layout, using mega cells stored in the mega cell library 35, by the design system shown in FIG. 14 is described using a flowchart of FIG. 15.

In steps S110 through S140, standard cell information of standard cells arranged in a synthesis area 101 is generated as with the example described using FIG. 3. The generated standard cell information is stored in a standard cell information area 24.

In step S145, the selecting module 15 reads the standard cell information from the standard cell information area 24. The selecting module 15 selects a mega cell from among mega cells stored in the mega cell library 35 based on the standard cell information. More specifically, the selecting module 15 selects a mega cell based on the types and number of standard cells arranged in the synthesis area 101. For example, a mega cell is selected according to the types of the standard cells arranged in the synthesis area 101 and the ratio of the number of the respective different standard cells. The selected mega cell is stored in a mega cell information area 25.

In steps S160 and S170, a layout module 14 carries out mapping using the mega cell selected in step S145 based on logic behavior information as with the example described using FIG. 3. The mapping results are stored in a second mapping information area 26 as the second mapping information. The layout module 14 makes a layout of the synthesis area 101 based on the second mapping information. Layout information is stored in a layout information area 27.

In step S145, if there are no appropriate mega cells in the mega cell library 35 that are consistent with the standard cell information, a new mega cell is generated using the same method as that described in step S150 of FIG. 3.

Used mega cells are stored in the memory cell library 35. In other words, mega cells that have passed the design rule check are stored in the mega cell library 35. Alternatively, mega cells that have been subjected to OPC may be stored. Therefore, it is unnecessary to carry out OPC for the selected mega cells when manufacturing a semiconductor integrated circuit including the selected mega cells stored in the mega cell library 35, since the stored mega cells have already been subjected to the same manufacturing process by the same apparatus. In other words, used mega cells can be utilized again as a design property. Therefore, when selecting a mega cell stored in the mega cell library 35, the mega cell generating process and the OPC process for mega cells may be omitted. As a result, the semiconductor integrated circuit design method according to the second embodiment of the present invention can reduce the mask design time. The other processes are substantially the same as the first embodiment, and repetitive description is thus omitted.

### Third Embodiment

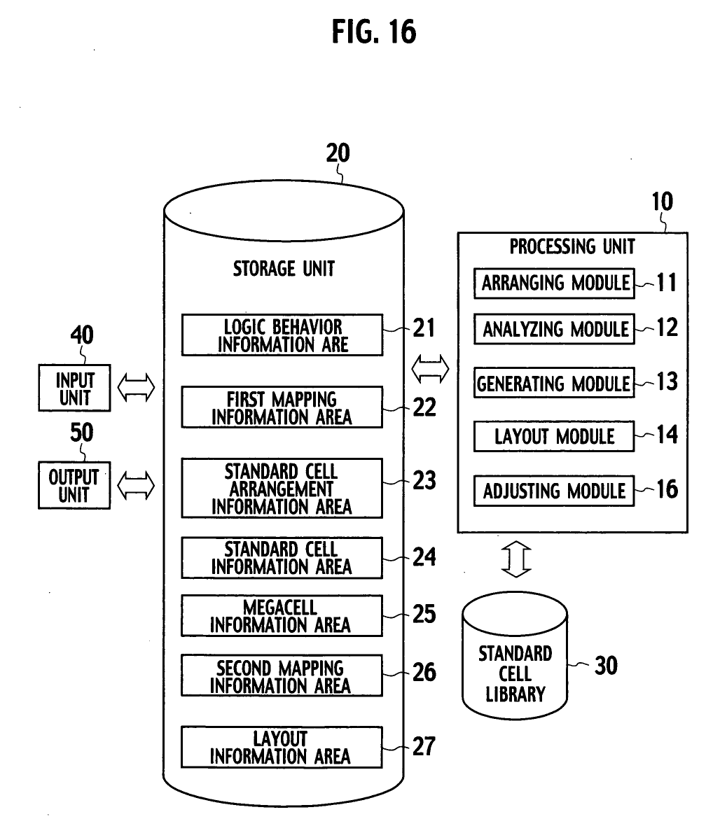

FIG. 16 shows a semiconductor integrated circuit design system, according to a third embodiment of the present invention. The design system shown in FIG. 16 is different from the design system shown in FIG. 1 in that the design system further includes an adjusting module 16. The adjusting module 16 finely adjusts a clock line load of each mega cell so that the total clock line loads of mega cells used within each synthesis area on the chip area 100 are the same.

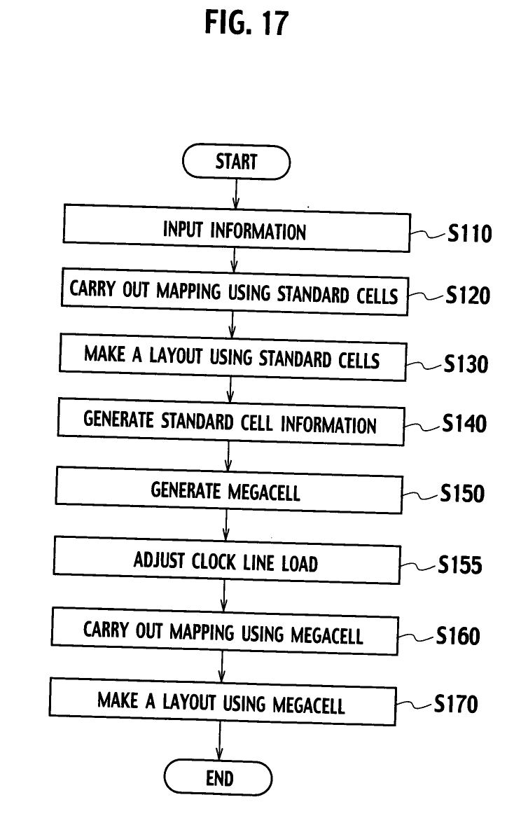

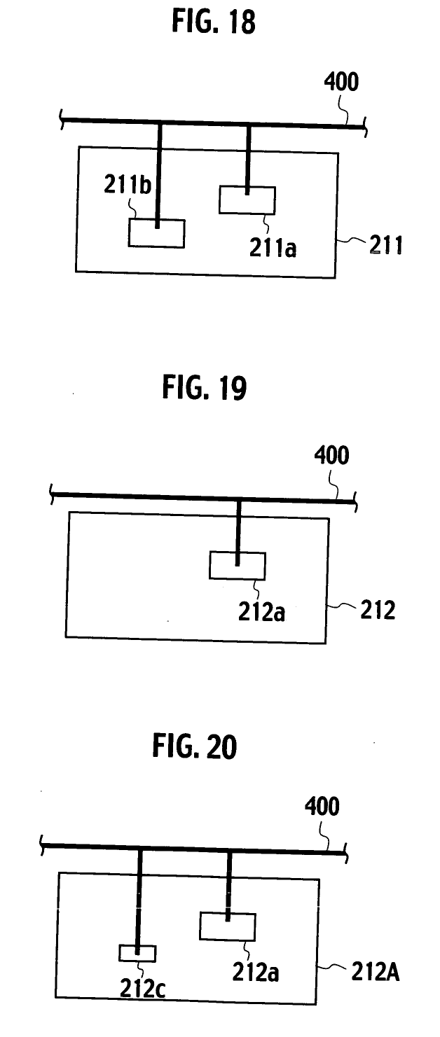

An example of designing a semiconductor integrated circuit by the design system shown in FIG. 16 is described using a flowchart shown in FIG. 17. A case of mega cells to be arranged in a synthesis area 101 including a mega cell 211 shown in FIG. 18 and a mega cell 212 shown in FIG. 19 is described forthwith.

As shown in FIG. 18, the mega cell 211 includes flip-flops 211a and 211b. As shown in FIG. 19, the mega cell 212 includes a flip-flop 212a. A clock signal transmitted from a clock buffer (not shown in the drawing) is provided to the flip-flops 211a, 211b, and 212a via a clock interconnect 400. In addition, input capacities of the clock input terminals of the respective flip-flops 211a and 212a are the same.

In steps S110 through S150 shown in FIG. 17, a mega cell to be arranged in the synthesis area 101 is generated in the same manner as the example described using FIG. 3. Mega cell information such as arrangement and shapes of standard cells included in the generated mega cells 211 and 212 is stored in a mega cell information area 25.

In step S155, the adjusting module 16 reads the mega cell information from the mega cell information area 25. The adjusting module 16 compares the arrangement of the standard cells comprising the mega cell 211 with arrangement of the standard cells comprising the mega cell 212. More specifically, the adjusting module 16 compares the mega cells 211 and 212 regarding the position and the number of the standard cells to which a clock signal is provided. The input capacities of the clock input terminals of the flip-flop 211a arranged in the mega cell 211 and the flip-flop 212a arranged in the mega cell 212 are the same. However, since the flip-flop 211b is arranged in the mega cell 211, the total clock line load of the mega cell 211 differs from the total clock line load of the mega cell 212. The adjusting module 16 finely adjusts the clock line load of the mega cell 212 so that the total clock line load of the mega cell 211 can be equal to the total clock line load of the mega cell 212. More specifically, as shown in FIG. 20, a capacitor 212c is arranged at the same position in a mega cell 211A as the position of the flip-flop 212b in the mega cell 211. The capacitance of the capacitor 212c is the same as the input capacitance of the clock input terminal of the flip-flop 211b. This makes the respective total clock line loads of the mega cells 211 and 212 the same. Information of the mega cell 212A in which the capacitor 212c is arranged is stored in the mega cell information area 25.

In steps S160 and S170, a layout module 14 carries out mapping using the mega cells 211 and 212 based on logic behavior information as with the example described in FIG. 3. The mapping results are stored in a second mapping information area 26 as the second mapping information. The layout module 14 makes a layout of the synthesis area 101 based on the second mapping information. Layout information is stored in a layout information area 27.

As described above, according to the semiconductor integrated circuit design method of the third embodiment, even when mega cells, each including differently arranged standard cells, are arranged in the synthesis area, the total clock line loads of all mega cells arranged in each synthesis area may be the same. Accordingly, a mega cell including a clock buffer can be arranged uniformly within the synthesis area. This facilitates clock line design, and the design time is reduced. Furthermore, when a plurality of synthesis areas exists on a chip, adjustment of the total clock line loads of the mega cells arranged in all synthesis areas to be the same reduces the entire amount of clock skew in each synthesis area of the chip. The other processes are substantially the same as the first embodiment, and repetitive description is thus omitted.

### Other Embodiments

In the first through the third embodiment described above, the method of generating or selecting mega cells based on standard cell arrangement information stored in the standard cell arrangement information area 23 is described. Alternatively, mega cells may be generated based on results from analyzing the first mapping information stored in the first mapping information area 22. This modification allows omission of steps S130 and 140 of FIG. 3.

Various modifications will become possible for those skilled in the art after receiving the teachings of the present disclosure without departing from the scope thereof.

What is claimed is:

1. A computer implemented method for designing a semiconductor integrated circuit, comprising:
analyzing information of standard cells to be arranged in a chip area based on circuit behavior information so as to generate standard cell information;
generating a mega cell including a group of standard cells based on the standard cell information; and
making a layout in which the same patterns repeat in the chip area by arranging a plurality of the mega cells having the same shape, throughout the chip area based on the circuit behavior information.

2. The method of claim 1, wherein the standard cell information includes types and number of standard cells.

3. The method of claim 1, further comprising generating:
a plurality of the standard cell information based on information of positions of the standard cells included in the information of the standard cells.

4. The method of claim 1, further comprising:
determining types and number of standard cells included in the group of standard cells, based on the standard cell information.

5. The method of claim 1, further comprising:
selecting the mega cell from among a plurality of mega cell in a mega cell library, based on the standard cell information.

6. The method of claim 1, further comprising:
adjusting a clock line load of the mega cell so that clock line loads of a plurality of the mega cells within the chip area are the same.

7. The method of claim 6, wherein the clock line load is adjusted by arranging a capacitance in the mega cell.

8. The method of claim 1, wherein the mega cell is rectangular.

9. A system for designing a semiconductor integrated circuit comprising:
an analyzing module configured to analyze information of standard cells to be arranged in a chip area based on circuit behavior information so as to generate standard cell information;
a generating module configured to generate a mega cell including a group of standard cells, based on the standard cell information; and
a layout module configured to make a layout in which the same patterns repeat in the chip area by arranging a plurality of the mega cells having the same shape, throughout the chip area based on the circuit behavior information.

10. The system of claim 9, wherein the standard cell information includes types and number of standard cells included in the information of the standard cells.

11. The system of claim 9, wherein the analyzing module generates a plurality of the standard cell information, based on information of positions of the standard cells included in the information of the standard cells.

12. The system of claim 9, wherein the generating module determines types and number of standard cells included in the group of standard cells, based on the standard cell information.

13. The system of claim 9, further comprising:
a mega cell library configured to store a plurality of mega cells.

14. The system of claim 13, further comprising:
a selecting module configured to select the mega cell from among the plurality of the mega cells stored in the mega cell library, based on the standard cell information.

15. The system of claim 9, further comprising:
an adjusting module configured to adjust a clock line load of the mega cell so that clock line loads of a plurality of the mega cells within the chip area are the same.

16. The system of claim 15, wherein the adjusting module adjusts the clock line load by arranging a capacitor in the mega cell.

17. The system of claim 9, further comprising:
an arranging module configured to arrange a plurality of the standard cells in the chip area, based on the circuit behavior information.

18. The system of claim 9, further comprising:
a standard cell library configured to store a plurality of the standard cells.

19. The system of claim 9, wherein the mega cell is rectangular.

20. A computer program product for controlling a design system so as to provide a semiconductor integrated circuit, comprising:
instructions configured to analyze information of standard cells to be arranged in a chip area, based on circuit behavior information, so as to generate standard cell information;
instructions configured to generate a mega cell including a group of standard cells, based on the standard cell information; and
instructions configured to make a layout in which the same patterns repeat in the chip area by arranging a plurality of the mega cells having the same shape, throughout the chip area based on the circuit behavior information.
